(19) United States
(12) Patent Application Publication
(10) Pub. No.: US 2023/0130260 A1
(43) Pub. Date: Apr. 27, 2023

(54) PRODUCTION OF A LIGNOCELLULOSE-CONTAINING, PLASTIC-COATED AND PRINTABLE MOLDING

(71) Applicants: PolymerTrend LLC, Orchard Park, NY (US); MZI Institut für Verfahrenstechnik, Stade (DE)

(72) Inventors: Max ZAHER, Stade (DE); Volker THOLE, Stade (DE)

(73) Assignees: PolymerTrend LLC, Orchard Park, NY (US); MZI Institut für Verfahrenstechnik, Stade (DE)

(21) Appl. No.: 17/914,173

(22) PCT Filed: Mar. 24, 2020
(86) PCT No.: PCT/EP2020/058087

§ 371 Date: Sep. 23, 2022

(51) Int. Cl. B27N 3/04; B27K 5/00; B27N 7/00; C08H 8/00; B41M 7/00; B32B 21/02; B32B 21/08

(52) U.S. Cl. CPC B27N 3/04; B27K 5/001; B27K 5/007; B27K 5/0035; B27N 7/005; B32B 21/02; B32B 21/08; B41M 7/0081; C08H 8/00; B27K 2200/10; B32B 2250/40; B32B 2307/75; B32B 2317/16

(57) ABSTRACT

A process for producing a lignocellulose-containing, plastic-coated and printable molding (26), in particular in sheet form, comprising the steps of:
a) producing a layer (A, B′) containing lignocellulose-containing particles according to the shape of the molding to be produced (26);
b) applying a layer (C) of particles containing electron beam-reactive thermoplastic onto the layer produced according to the preceding feature;
c) heating the layers (A, C) produced according to the preceding features such that thermoplastic particles melt into the layer containing lignocellulose-containing particles (Cs);
d) pressing the layers heated according to feature (1c); and
e) irradiating the layers pressed according to feature (1d) with electrons in the energy range from 1 MeV to 10 MeV. The process is for example elucidated with reference to an MDF sheet one-sidedly provided with a polymer layer.

The invention relates to processes and apparatuses for producing a lignocellulose-containing, plastic-coated printable molding.

The processes and apparatuses use lignocellulose-containing particles. There come into consideration here as lignocellulose-containing particles in particular substances made of wood or of non-woody plants or also a mixture thereof, for example in the form of chips, fibers, so-called strands or flakes. The particles mentioned here thus include in particular woody and ligneous chips and fibers.

Wood chips or wood fibers, or ligneous chips or fibers, are here to be understood as being in particular native cellulose-containing raw materials, for example wood from various tree species and of various origins (fresh, old or recycled).

Other examples of ligneous chips or fibers within the meaning of this description are bamboo, straw from maize or cereals, fiber plants such as flax or jute.

The use of ionizing radiation for the treatment, in particular for the digestion, of native cellulose-containing raw materials for various further processing purposes is known per se. Examples are pest decontamination, facilitation of so-called refining, or fiber digestion, in paper production, or also the acceleration of saccharification and fermentation, for example in the production of bioethanol.

The invention relates in particular to the production of chipboard and MDF/HDF sheets.

In the prior art it is known to use for this purpose a chopper for chopping the ligneous starting materials, a chipper for producing chips, a screen for determining the chip or fiber sizes, a washing installation, a so-called defibrator (in MDF production), a dryer, a mixer for mixing the chips or fibers with a binder, in particular the component formaldehyde, an installation for producing a mat, a pre-press, and a full press with heating to 220° C. for example, as well as means for the after-treatment of the chipboard or MDF/HDF sheets. The use of formaldehyde is problematic here with regard to health protection and the risk of fire.

The prior art is to be improved in particular in respect of the following properties and parameters:

productivity in production, outlay in terms of energy, required temperatures, mixing and setting times, cooling times, thickness swelling, abrasion and bending strength (modulus of elasticity), transverse tensile strength, ease of further processing, printability, UV protection, resistance to temperature changes and moisture, bioresistance of the products to spores, fungi, insects, fire protection, health protection, etc.

International patent application PCT/EP 2019/074883 of the inventors, knowledge of which is here assumed, describes the production of a lignocellulose-containing molding, wherein at least some of the above-mentioned aims are at least partially achieved.

The present invention relates additionally to the problem of printing lignocellulose-containing moldings, that is to say in particular chipboard and MDF/HDF sheets.

In the prior art, the printing, for example by laser printing or inkjet printing, of lignocellulose-containing moldings, in particular chipboard and MDF/HDF sheets, is very complex. The moldings or sheets must be lacquered multiple times in respect of their surface, typically in more than 3 steps. This is complex and expensive in terms of equipment and in terms of the process.

Accordingly, the object of the present invention is to provide processes and apparatuses with which a lignocellulose-containing molding can be produced with a minimal outlay in terms of equipment and in terms of the process, in particular such that it is printable and optionally printed.

According to the invention, a process for producing a lignocellulose-containing, plastic-coated and printable molding, in particular in sheet form and in the form of an MDF/HDF sheet, comprises the following steps:
a) producing a layer (A, B′) containing lignocellulose-containing particles according to the shape of the molding (26) to be produced;
b) applying a layer (C) of particles containing electron-beam-reactive thermoplastic to the layer produced according to the preceding feature;
c) heating the layers (A, C) produced according to the preceding features such that thermoplastic-containing particles melt into the layer containing lignocellulose-containing particles (Cs);
d) pressing the layers heated according to feature (1c); and
e) irradiating the layers pressed according to feature (1d) with electrons in the energy range from 1 MeV to 10 MeV.

With such a process, MDF/HDF moldings, in particular sheets, can advantageously be so produced in respect of the above-mentioned problems/aims that they have an outer polymer layer which is readily printable, in particular by laser printing or by inkjet printing.

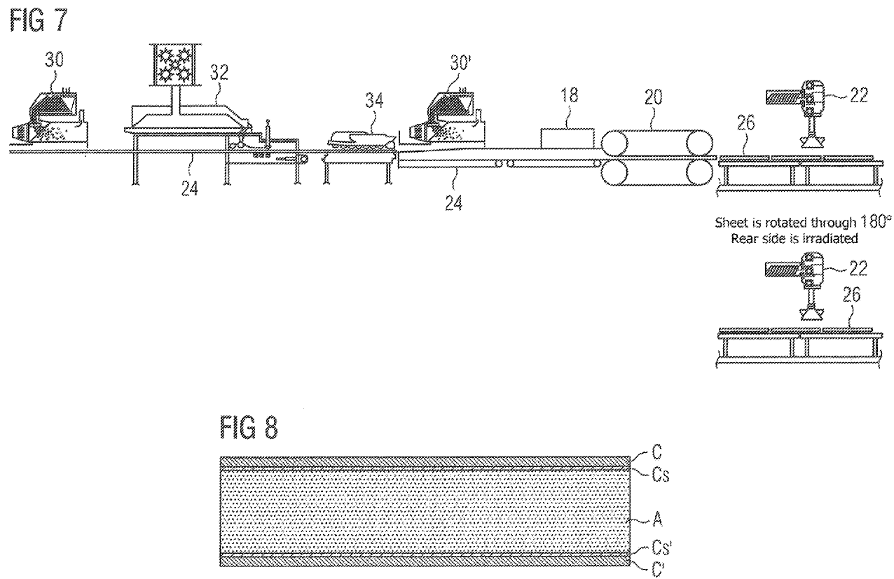

According to one embodiment of the above-mentioned process, it is provided, in particular for producing MDF/HDF moldings, in particular sheets, that are provided with an outer polymer layer on both sides, according to FIGS. 7, 8, to produce, prior to the above-mentioned step a), a layer of particles containing an electron-beam-reactive thermoplastic, to which there is applied the layer containing lignocellulose-containing particles according to the above step a). The mentioned particles containing electron-beam-reactive thermoplastic preferably consist substantially of thermoplastic.

The above-mentioned process steps are preferably carried out one after the other in terms of time, in the indicated order. The heating according to feature 1c) and the pressing according to feature d) can thereby be carried out wholly or partially overlapping in terms of time.

For producing an MDF/HDF molding in which the surface arranged on the bottom during production is provided with the readily printable polymer layer, the process is as follows:
production of a layer of particles containing electron-beam-reactive thermoplastic;
application of a layer containing lignocellulose-containing particles according to the shape of the molding to be produced;
heating of the layers produced according to the preceding features such that thermoplastic-containing particles melt into the layer containing lignocellulose-containing particles;
pressing of the layers heated according to the preceding feature; and
irradiation of the layers pressed according to the preceding feature with electrons in the energy range from 1 MeV to 10 MeV.

The above-mentioned “melting in” of thermoplastic-containing particles, which may also be particles consisting wholly of thermoplastic, means that the entire ply of thermoplastic-containing particles does not melt in, but only part thereof penetrates by melting as a result of heating into the adjacent layer containing lignocellulose-containing particles (i.e. in particular wood particles) and thus effects optimal bonding of the layers, while there is formed on the outer side of the molding a smooth layer of substantially thermoplastic material, which is printable, in particular by inkjet printing or by laser printing, without complex further measures.

For producing chipboard with a polymer coating on one side, the layer according to feature a) above contains fine lignocellulose-containing particles and the following steps are carried out after step a) and before step b):

aa) application of a layer (A′) containing coarse lignocellulose-containing particles.

Where mention is made herein of a “layer according to the shape of the molding to be produced”, this means that the shape of the layer is not necessarily identical to the final shape of the molding but is only dependent on the latter shape.

The invention relates also to apparatuses for carrying out the above-mentioned processes, wherein, for the individual process steps mentioned above, a device is provided in each case for carrying out the process step.

The processes according to the invention can also be used to bring a molding produced in the conventional manner, such as a chipboard or an MDF/HDF sheet, into a readily printable state. To this end, there can be spread on the conventionally produced chipboard or the MDF/HDF sheet a layer of particles which contain electron-beam-reactive thermoplastic or consist substantially thereof, following which the intermediate product so produced is heated such that some of the thermoplastic particles penetrate by melting into the adjacent layer containing lignocellulose-containing particles, whereupon the intermediate product so produced is pressed and then irradiated with electrons in the mentioned energy range.

The above-mentioned heating of the layers which have been produced such that thermoplastic-containing particles melt into the layer containing lignocellulose-containing particles is preferably carried out at temperatures of from 100° C. to 180° C., in particular at from 160° C. to 170° C.

The above-mentioned pressing operation is carried out in particular with pressures of from 30 bar to 50 bar.

Mention is made hereinbefore on the one hand of layers containing electron-beam-reactive thermoplastic and on the other hand of layers containing lignocellulose-containing particles. These are preferably on the one hand layers substantially containing thermoplastic and on the other hand layers substantially containing ligneous particles. The particles are in each case suitable for spreading in the surface.

There can be admixed with the layers containing lignocellulose-containing particles in each case a polymer (likewise in particle form), wherein these admixed polymer particles, on irradiation with electrons, effect total crosslinking with inclusion of the lignocellulose particles and of the polymers.

The lignocellulose-containing particles can also be irradiated with electrons in the energy range from 1 MeV to 10 MeV prior to or during their first use in one of the processes mentioned herein. Such irradiation is accordingly then carried out twice in the process.

There can be admixed with the layers of lignocellulose-containing particles (wood particles) mass proportions of from 5% to 30% of a thermoplastic. For producing a so-called WPC molding (wood-plastic composite), mass proportions of preferably from 30% to 60% of a polymer of the above-mentioned type are admixed.

Exemplary embodiments of the invention will be described in greater detail hereinbelow with reference to the accompanying figures.

FIG. 1 shows the production of a chipboard without a polymer coating;

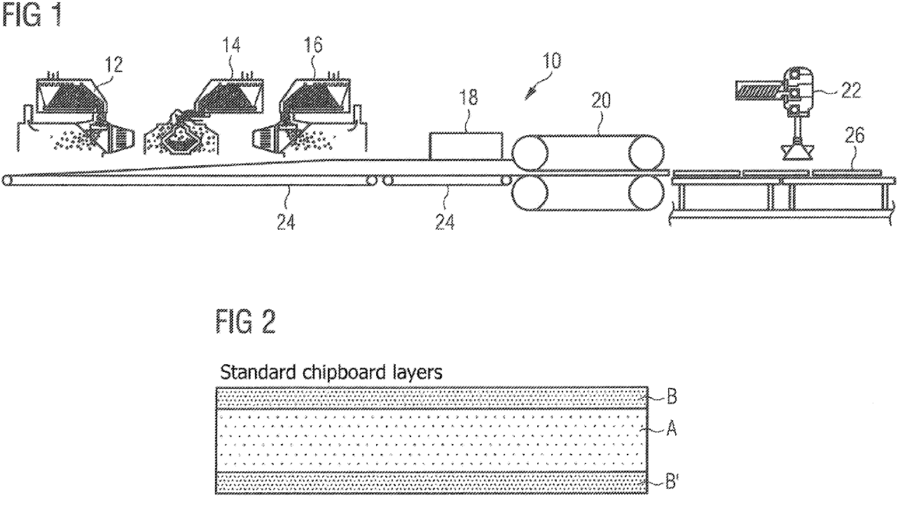

FIG. 2 shows a standard chipboard in section, as has been produced with an apparatus and a process according to FIG. 1;

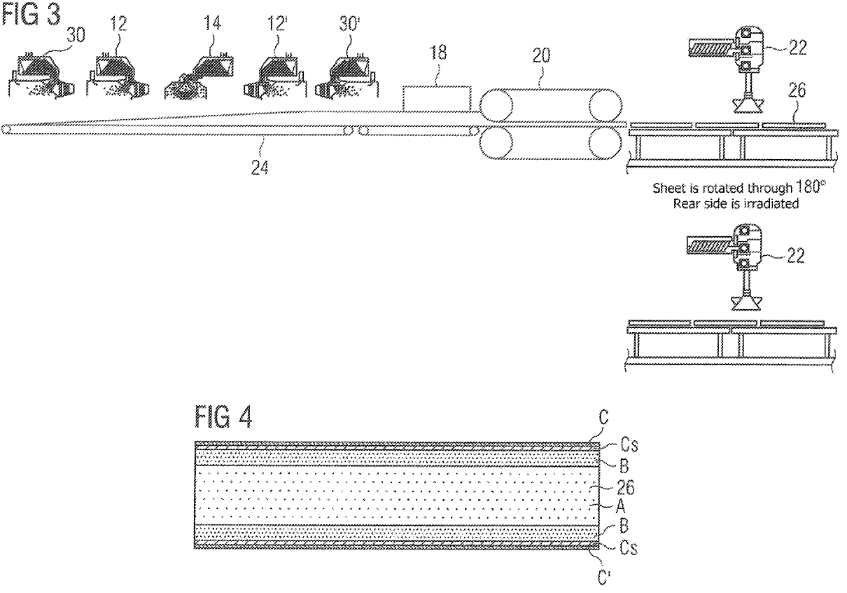

FIG. 3 shows the production of a chipboard with a polymer layer on both sides;

FIG. 4 shows a chipboard with polymer layers on both sides produced using an apparatus according to FIG. 3;

FIG. 5 shows the production of a chipboard with a polymer layer on one side;

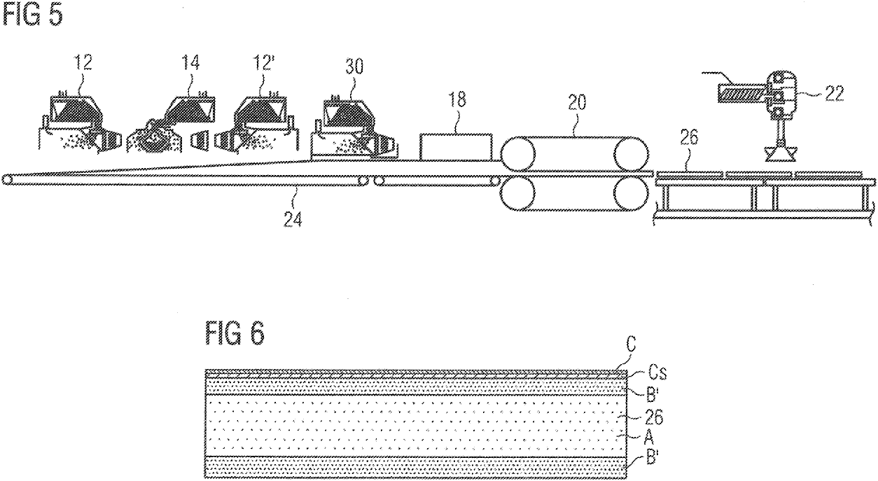

FIG. 6 shows a chipboard with a polymer layer on one side produced using an apparatus according to FIG. 5;

FIG. 7 shows the production of an MDF/HDF sheet with polymer layers on both sides;

FIG. 8 shows an MDF/HDF sheet with polymer layers on both sides produced using an apparatus according to FIG. 7;

FIG. 9 shows the production of an MDF/HDF sheet with a polymer layer on one side; and

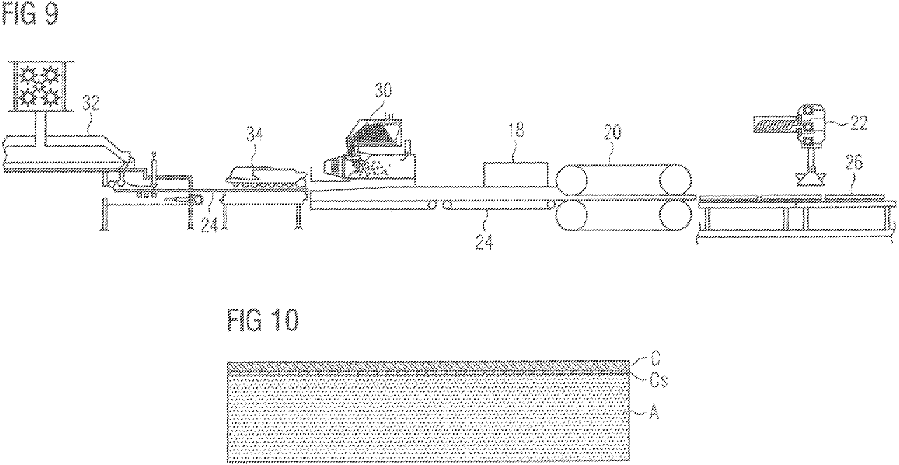

FIG. 10 shows an MDF/HDF sheet with a polymer layer on one side produced using an apparatus according to FIG. 9.

FIG. 1 explains generally an apparatus and a process 10 for producing a conventional chipboard as the starting point of the present invention.

The process proceeds in FIG. 1 temporally and spatially from left to right.

“Lignocellulose-containing particles” are by way of example “wood particles” hereinbelow.

Firstly, in a manner known per se, a fine wood particle spreader spreads fine wood particles extensively on a conveyor belt 24 to produce a layer of fine wood particles. The term “wood dust” is also commonly used for such fine wood particles.

A coarse wood particle spreader 14 spreads a layer of coarse wood particles onto the layer of fine wood particles. The coarse wood particles can also be referred to as wood chips. Subsequently, a further fine wood particle spreader 16 spreads a layer of fine wood particles onto the layer of coarse wood particles. The fine particles and the coarse particles, as they are used here, have dimensions as are conventional in the production of three-layer chipboard. The fine particles thus have smaller dimensions than the coarse particles.

The conveyor belt 24 conveys the three layers so spread one on top of the other into a preheater 18 and, from there, the layers enter a press 20. Downstream of the press 20, the pressed moldings 26 are conveyed to an electron emitter 22, where they are irradiated with electrons in the energy range between 1 MeV and 10 MeV.

FIG. 2 shows a standard chipboard so produced, with a central coarse wood particle layer A, an upper fine wood particle layer B and a lower fine wood particle layer B′.

This is the basic structure on which the present invention is based.

In the figures, mutually corresponding components are provided with the same reference signs, wherein components used in different places are optionally provided with a prime or with a double prime.

FIG. 3 shows an apparatus and a process for producing a chipboard which is provided with a polymer layer on both sides. A polymer which is thermoplastically deformable and meltable by the action of heat is referred to hereinbelow as a thermoplastic.

A thermoplastic particle spreader 30 spreads a layer of fine thermoplastic particles on the conveyor belt 24. A fine wood particle spreader 12 then spreads a layer of fine wood particles on the layer of thermoplastic particles. Then a coarse wood particle spreader spreads a layer of coarse wood particles on the mentioned layer of fine wood particles. Then a further fine wood particle spreader 12′ spreads a layer of fine wood particles on the layer of coarse wood particles. A further thermoplastic particle spreader 30′ then spreads a layer of fine thermoplastic particles on the layer of fine wood particles which has been produced.

The layer thicknesses of the mentioned thermoplastic particle layers are preferably in the range from 100 to 500 micrometers (µm). Preferably, in all the two-sided coatings described here, the thickness of the polymer layers produced with the thermoplastic particles on both sides of the molding is the same. This has the advantage that warping (deformation) of the molding is counteracted (the so-called “banana effect” is avoided).

Downstream of the thermoplastic particle spreader 30′ according to FIG. 3, the intermediate product with the mentioned five layers (plies) is conveyed into a preheater 18 where, according to the polymers or thermoplastics used, heating to temperatures in the range from 100 to 180° C., typically in the range from 160 to 170° C., takes place. The thermoplastic particles thereby melt, and molten thermoplastic partially penetrates into the adjacent layer of fine wood particles and thus produces an intimate bond between the polymer layer and the wood particle layer. The intermediate product so treated is then guided into a press 20, where the sheets are pressed with pressures of between 30 and 50 bar. The intermediate products are then guided into the electron emitter 22 and irradiated over their entire surface with electrons in the energy range between 1 MeV and 10 MeV. The sheets are then turned through 180° and the other side of the sheets is likewise irradiated with electrons in the energy range between 1 MeV and 10 MeV.

FIG. 4 shows the molding 26 so produced in section. A central coarse wood particle layer A has fine wood particle layers B on both sides. On the outside, there are polymer layers C, C′ on both sides. The outer polymer layers C, C′ are each bonded via molten bond layers Cs to the adjacent fine wood particle layer. On heating, molten thermoplastic particles flow between the fine wood particles.

FIG. 5 shows an apparatus for producing a chipboard with a polymer layer on one side. Following a first fine wood particle spreader 12, a coarse wood particle spreader 14 and a second fine wood particle spreader 12′, a thermoplastic particle spreader 30 applies an upper layer of thermoplastic particles, following which preheating and pressing are carried out by means of a preheater 18 and a press 20, and the moldings 26 are irradiated with electrons in an electron emitter 22, as described above with reference to FIG. 3.

The observations made above in connection with FIG. 3 and FIG. 4 with regard to layer thicknesses, polymers admixed with the wood parts, etc. apply to all the exemplary embodiments.

The molding 26 produced using the apparatus according to FIG. 5 is shown in section in FIG. 6. A central coarse wood particle layer A′ has fine wood particle layers B′ on both sides and a polymer layer C on one side, which polymer layer is fixedly bonded to the fine wood particle layer B′ beneath it via a molten bond layer Cs.

FIG. 7 shows an apparatus for producing an MDF/HDF sheet (medium-density fiberboard/high-density fiberboard) with a polymer layer both on the upper side and on the lower side.

A thermoplastic particle spreader 30 spreads a layer of thermoplastic particles on the conveyor belt. A wood fiber spreader 32 spreads a layer of wood fibers on the mentioned layer of thermoplastic particles. A mat former 34 shapes the two mentioned layers into a mat. A second thermoplastic particle spreader 30′ spreads a layer of thermoplastic particles on the mat. The intermediate product so produced then enters, in the manner already described, a preheater 18 and a press 20 as well as an electron emitter 22 in the manner described above with reference to FIG. 5, for example.

FIG. 8 shows the molding so produced and is self-explanatory because the reference numerals have already been explained above.

FIG. 9 shows an apparatus for producing an MDF sheet with a polymer layer on only one side. A wood fiber spreader 332 spreads a layer of wood fibers. A mat former 34 shapes the wood fiber layer so produced. A thermoplastic particle spreader 30 spreads a layer of thermoplastic particles thereon. From there, the intermediate product enters the preheater 18, the press 20 and the electron emitter 22, as described above.

FIG. 10 shows the MDF sheet so produced with a polymer layer applied to one side.

In all the exemplary embodiments described above, polymers which crosslink under electron bombardment can be added to the fine wood particle layers and the coarse wood particle layers.

The references to figures in the claims serve to facilitate correlation with the exemplary embodiments and are not part of the claims.

### LIST OF REFERENCE SIGNS

10 chipboard production
12 fine wood particle spreader
14 coarse wood particle spreader
16 fine wood particle spreader
18 preheater
20 press
22 electron emitter
24 conveyor belt
26 molding (chipboard)
30 thermoplastic particle spreader
12′ fine wood particle spreader
14′ coarse wood particle spreader
30′ thermoplastic particle spreader
12″ fine wood particle spreader
14″ coarse wood particle spreader
30″ thermoplastic particle spreader
A coarse wood particle layer
B fine wood particle layer
B′ fine wood particle layer
C polymer layer
Cs molten bond layer
C′ polymer layer
32 wood fiber spreader
34 mat former

1. A process for producing a lignocellulose-containing, plastic-coated and printable molding (26), in particular in sheet form, comprising the following steps:
a) producing a layer (A, B′) containing lignocellulose-containing particles according to the shape of the molding (26) to be produced;
b) applying a layer (C) of particles containing electron-beam-reactive thermoplastic to the layer produced according to the preceding feature;
c) heating the layers (A, C) produced according to the preceding features such that thermoplastic-containing particles melt into the layer containing lignocellulose-containing particles (Cs);
d) pressing the layers heated according to feature (1c); and
e) irradiating the layers pressed according to feature (1d) with electrons in the energy range from 1 MeV to 10 MeV.
(FIGS. 9, 10; MDF, on one side, thermoplastic, on the top).

2. The process as claimed in claim 1, wherein, prior to step 1a), a layer (C′) of particles containing electron-beam-reactive thermoplastic is produced, to which there is applied the layer containing lignocellulose-containing particles according to step 1a). (FIGS. 7, 8; MDF, thermoplastic on both sides).

3. The process as claimed in either claim 1 or claim 2, wherein the layer produced according to feature 1a) contains electron-beam-reactive thermoplastic polymer in powder form with powder particle sizes < 2000 micrometers (µm) or a liquid containing electron-beam-reactive polymer.

4. The process as claimed in claim 2, wherein step 1b) is omitted. (MDF, on one side, thermoplastic on the bottom).

5. The process as claimed in any one of the preceding claims, wherein the mentioned layers are produced by spreading particles.

6. The process as claimed in either claim 1 or claim 3, wherein the order of process steps 1a) and 1b) is reversed. (MDF, thermoplastic on one side, on the bottom).

7. The process as claimed in any one of claims 1 to 5, wherein the layer (B′) produced according to feature 1a) contains fine lignocellulose-containing particles, and the following steps are carried out after step 1a) and before step 1b):
aa) application of a layer (A′) containing coarse lignocellulose-containing particles; and
ab) application of a layer (B′) containing fine lignocellulose-containing particles.
(FIGS. 5, 6; chipboard, thermoplastic on one side, on the top).

8. The process as claimed in claim 7, wherein the layers applied according to feature 7aa) and/or according to feature 7ab) contain thermoplastic polymer in powder form with powder particle sizes < 2000 micrometers (µm) or a liquid containing electron-beam-reactive polymer.

9. An apparatus for producing a lignocellulose-containing, plastic-coated and printable molding (26), in particular in sheet form, comprising the following:
a) a particle spreader (32) for producing a layer (A, B′) containing lignocellulose-containing particles according to the shape of the molding (26) to be produced;
b) a particle spreader (30) for applying a layer (C) of particles containing electron-beam-reactive thermoplastic to the layer produced according to the preceding feature;
c) a heater (18) for heating the layers (A, C) produced according to the preceding features such that thermoplastic-containing particles melt into the layer containing lignocellulose-containing particles (Cs);
d) a press (20) for pressing the layers heated according to feature (1c); and
e) an electron emitter (22) for irradiating the layers pressed according to feature (1d) with electrons in the energy range from 1 MeV to 10 MeV.
(FIGS. 9, 10; MDF, on one side, thermoplastic, on the top).

10. The apparatus as claimed in claim 9, wherein there is arranged upstream of the particle spreader according to feature 9a) a particle spreader (30) for producing a layer (C′) of particles containing electron-beam-reactive thermoplastic. (FIGS. 7, 8; MDF, thermoplastic, on both sides).

11. The apparatus as claimed in either claim 9 or claim 10, wherein the layer produced by the particle spreader according to feature 9a) contains electron-beam-reactive thermoplastic polymer in powder form with powder particle sizes < 2000 micrometers (µm) or a liquid containing electron-beam-reactive powder.

12. The apparatus as claimed in claim 10, wherein the particle spreader according to feature 9b) is omitted.

13. The apparatus as claimed in either claim 9 or claim 11, wherein the order in which the particle spreaders according to features 9a) and 9b) are arranged is reversed.

14. The apparatus as claimed in any one of claims 9 to 13, wherein the layer (B′) produced by the powder spreader according to feature 9a) contains fine lignocellulose-containing particles, and there are arranged in the arrangement of the mentioned particle spreaders downstream of the particle spreader according to feature 9a) and upstream of the particle spreader according to feature 9b):
aa) a particle spreader (14) for applying a layer (A′) containing coarse lignocellulose-containing particles; and
ab) a particle spreader (12′) for applying a layer (B′) containing fine lignocellulose-containing particles.
(FIGS. 5, 6; chipboard, thermoplastic on one side, on the top).

15. The apparatus as claimed in claim 14, wherein the layers applied according to feature 14aa) and/or according to feature 14ab) contain thermoplastic polymer in powder form with powder particle sizes < 2000 micrometers (µm) or a liquid containing electron-beam-reactive polymer.

16. The process or apparatus as claimed in any one of the preceding claims, characterized by printing of the molding which has been produced by laser jet printing or inkjet printing.
